(19) United States
(12) Patent Application Publication
(10) Pub. No.: US 2019/0391666 A1
(43) Pub. Date: Dec. 26, 2019

(54) GESTURE RECOGNITION APPARATUS AND METHOD

(71) Applicant: LG ELECTRONICS INC., Seoul (KR)

(72) Inventor: Dae Ok KIM, Anyang-si (KR)

(73) Assignee: LG ELECTRONICS INC., Seoul (KR)

(21) Appl. No.: 16/559,993

(22) Filed: Sep. 4, 2019

(30) Foreign Application Priority Data
Jul. 1, 2019 (KR) 10-2019-0078593

(51) Int. Cl. G06F 3/01; G06F 3/16; G06K 9/00; G06N 3/08; G06N 20/00

(52) U.S. Cl. CPC G06F 3/017; G06F 3/011; G06N 20/00; G06K 9/00335; G06N 3/08; G06F 3/167

(57) ABSTRACT

Disclosed are an apparatus and method for recognizing a gesture through machine learning and a deep neural network model. The gesture recognition apparatus includes an image sensor for sensing an input image, a communicator for communicating with an external server, an output unit for outputting the result of a command indicated by a gesture, and a controller. The controller is configured to process an image of a gesture in order to determine the type of the gesture, and the content of a command of the gesture, and output the result thereof when the gesture is a first type, or transmit information about the gesture to the external server through the communicator when the gesture is a second type. The gesture recognition apparatus may be connected to other electric home appliances over a 5G communication network so as to be operated in an Internet of Things (IoT) environment.

### CROSS-REFERENCE TO RELATED APPLICATION

Pursuant to 35 U.S.C. § 119(a), this application claims the benefit of an earlier filing date and priority to Korean Application No. 10-2019-0078593 filed in the Republic of Korea on Jul. 1, 2019, the contents of which are incorporated by reference herein in its entirety.

### BACKGROUND OF THE INVENTION

### Field of the Invention

The present disclosure relates to a gesture recognition apparatus and method, and more particularly, to a gesture recognition apparatus and method enabling a local device or an external server to analyze a gesture depending on the type of the gesture.

### Discussion of the Related Art

A method enabling an electronic device to recognize a user's command has developed from using a separate input tool, such as a button, a keyboard, or a mouse, to direct recognition of a user's voice or gesture. For example, artificial intelligence speakers designed to receive a user's voice and comprehend a command that the user intends to perform using their voice through natural language processing are being used. Furthermore, in recent years, technologies for recognizing a user's gesture and more effectively comprehending a command that the user intends to perform have been proposed.

In connection therewith, U.S. Pat. No. 9,207,768 discloses an apparatus and method for controlling a mobile terminal using user interaction recognized through vision recognition, wherein it is determined whether a specific object in a vision recognition image is a person, and when the specific object is a person, a gesture of the specific object is determined in order to determine whether a recognized motion is based on a command of the person. However, the above patent proposes only a method of determining whether the gesture is a gesture for a command, and does not disclose a method for effectively analyzing the gesture after recognizing that the gesture is a gesture for a command.

In addition, U.S. Pat. No. 9,495,758 discloses a gesture recognition method and apparatus capable of estimating the directional sequence of an inputted gesture based on previous directional information and current directional information of the gesture, so that the gesture recognition apparatus can more accurately recognize the gesture. However, the above patent discloses only a method for improving the recognition of a gesture irrespective of the processing ability of a device, and does not consider limitations in the processing ability required for gesture analysis.

Further, gesture analysis is a task requiring complicated image analysis. For this reason, there is a need for a method of effectively performing a gesture analysis task in consideration of processing speed and processing ability.

The above information disclosed in this Background section is provided only for enhancement of understanding of the background of the present disclosure and therefore it may contain information that does not form the prior art that is already known in this country to a person of ordinary skill in the art.

### SUMMARY OF THE INVENTION

The present disclosure is directed to preventing processing resources from wastage and overloading due to the recognition and analysis of all gestures being performed by a single device even though processing ability required for a task of recognizing and analyzing a gesture varies depending on the complexity of the gesture.

The present disclosure is further directed to preventing a motion that does not correspond to a gesture for a command from being wrongly recognized as a gesture command, and preventing standby power necessary for gesture recognition from being wasted.

The present disclosure is further directed to preventing wastage of resources due to gesture images being collected with the same degree of detail even though the degree of detail of the gesture images to be collected varies for each gesture.

The present disclosure is further directed to preventing wastage of transmission ability and analysis ability due to a gesture image itself being transmitted as an object of analysis.

Embodiments of the present disclosure provide a method and apparatus enabling different devices to analyze a gesture depending on the type of the gesture, whereby a simple gesture is analyzed by a local device having a relatively low processing ability, and a complicated gesture is analyzed by an external server having a relatively high processing ability.

An aspect of the present disclosure is to provide a gesture recognition apparatus and method capable of analyzing the type of an input gesture, enabling a predetermined type of gesture to be analyzed by the gesture recognition apparatus, and transmitting another type of gesture to an external server, which analyzes the received gesture.

Another aspect of the present disclosure is to provide a gesture recognition apparatus and method capable of receiving a user's voice, and when the voice signal is determined to be a wake-up word for initiating interaction with the user, activating an image sensor in order to receive a gesture command.

A further aspect of the present disclosure is to provide a gesture recognition apparatus and method capable of activating an image sensor only when a user is near a device, and even when the image sensor is activated, differentially activating a first image sensor and a second image sensor of the image sensor depending on the circumstances.

A gesture recognition apparatus according to an embodiment of the present disclosure may include an image sensor for sensing an input image, a communicator for communicating with an external server, and a controller for controlling the image sensor and the communicator.

The controller may be configured to determine the type of a gesture, determine the content of a command indicated by the gesture and perform the command when the gesture is a first type gesture, and transmit information about the gesture to the external server through the communicator when the gesture is a second type of gesture.

In a gesture recognition apparatus according to another embodiment of the present disclosure, the controller may be further configured to process the input image through a deep neural network model pre-trained to specify a gesture corresponding to an input image.

A gesture recognition apparatus according to still another embodiment of the present disclosure may further include a voice sensor unit for sensing a user's voice, and the controller may be further configured to activate the image sensor upon determining that a voice signal sensed by the voice sensor unit corresponds to a wake-up word.

A gesture recognition apparatus according to yet another embodiment of the present disclosure may further include a proximity sensor for sensing a human body approaching within a predetermined range. The controller may be further configured to activate the image sensor when the proximity sensor has sensed the human body.

The image sensor may include a first image sensor and a second image sensor. In addition, the controller may be further configured to initially activate only the first image sensor, and to secondarily activate the second image sensor in addition to the first image sensor upon determining that an image sensed by the first image sensor is a wake-up word gesture.

A gesture recognition apparatus according to still another embodiment of the present disclosure may further include a voice sensor unit for sensing a user's voice. The controller may be further configured to activate a voice recognition mode upon determining that a gesture corresponding to the input image sensed by the activated image sensor is a wake-up word gesture.

In a gesture recognition apparatus according to yet another embodiment of the present disclosure, the controller may be further configured to process the input image, convert the processed input image into simplified gesture data including information about the directions of fingers making the gesture, and transmit the simplified gesture data to the external server as information about the gesture through the communicator, when the gesture is the second type of gesture.

In a gesture recognition apparatus according to yet another embodiment of the present disclosure, the controller may be further configured to, when a first input image indicating a first gesture and a second input image indicating a second gesture, received by the image sensor, are successively sensed within a predetermined time, create gesture group data in which the first gesture and the second gesture are grouped and transmit the gesture group data to the external server as information about the gesture through the communicator.

A gesture recognition method according to an embodiment of the present disclosure may include acts of sensing an input image through an image sensor, determining a gesture corresponding to the input image and the type of the gesture by processing the input image, determining the content of a command indicated by the gesture and performing the command when the gesture is a first type gesture, and transmitting information about the gesture to an external server when the gesture is a second type of gesture.

In a gesture recognition method according to another embodiment of the present disclosure, the act of determining the type of the gesture may include processing the input image through a deep neural network model pre-trained to specify a gesture corresponding to an input image.

A gesture recognition method according to still another embodiment of the present disclosure may further include acts of sensing a user's voice through a voice sensor unit, determining whether a voice signal sensed by the voice sensor unit corresponds to a wake-up word, and activating the image sensor when the voice signal corresponds to the wake-up word, before the act of sensing the input image through the image sensor is performed.

A gesture recognition method according to yet another embodiment of the present disclosure may further include acts of sensing a human body approaching within a predetermined range through a proximity sensor, and activating the image sensor upon determining that the proximity sensor has sensed a human body, before the act of sensing the input image through the image sensor is performed.

Here, the image sensor may include a first image sensor and a second image sensor. In addition, the act of activating the image sensor may include activating only the first image sensor, and the act of sensing the input image through the image sensor may include determining whether a gesture corresponding to an image sensed by the first image sensor is a wake-up word gesture, activating the second image sensor in addition to the first image sensor when the gesture corresponding to the image is the wake-up word gesture, and sensing the input image through the first image sensor and the second image sensor.

A gesture recognition method according to still another embodiment of the present disclosure may further include activating a voice recognition mode when the gesture is a wake-up word gesture, after the act of sensing the input image through the image sensor is performed.

In a gesture recognition method according to yet another embodiment of the present disclosure, the act of transmitting information about the gesture to an external server may include processing the input image and converting the processed input image into simplified gesture data including information about the directions of fingers making the gesture when the gesture is the second type of gesture, and transmitting the simplified gesture data to the external server as information about the gesture.

In a gesture recognition method according to still another embodiment of the present disclosure, the act of transmitting information about the gesture to an external server may include, when a first input image indicating a first gesture and a second input image indicating a second gesture, received by the image sensor, are successively sensed within a predetermined time, creating gesture group data in which the first gesture and the second gesture are grouped, and transmitting the gesture group data to the external server as information about the gesture.

A computer program according to an embodiment of the present disclosure may be a computer program stored in a computer-readable recording medium in order to perform any one of the methods described above using a computer.

By assigning gesture analysis tasks such that gestures are analyzed by devices having different processing abilities depending on the complexity of the gestures, the gesture recognition apparatus and method according to the embodiments of the present disclosure may enable gesture analysis to be efficiently performed while processing ability is not wasted and overloading does not occur.

Further, the gesture recognition apparatus and method according to the embodiments of the present disclosure may enable effective determination of whether a motion near the apparatus is a gesture for a command, and thereby conserve standby power necessary for gesture recognition.

The gesture recognition apparatus and method according to the embodiments of the present disclosure may enable adjustment of the degree of detail of a gesture image to be collected depending on the circumstances, and thereby enable efficient use of resources necessary to process the gesture image.

The gesture recognition apparatus and method according to the embodiments of the present disclosure may enable extraction and transmission of only essential information necessary to specify a gesture from a gesture image, and thereby enable efficient use of transmission resources and analysis resources.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating a gesture recognition system according to an embodiment of the present disclosure;

FIG. 2 is block diagram of a gesture recognition apparatus according to an embodiment of the present disclosure and external devices with which the gesture recognition apparatus communicates;

FIG. 3 is a flowchart illustrating a gesture recognition method according to an embodiment of the present disclosure;

FIG. 4 is a flowchart illustrating the gesture recognition method according to an embodiment of the present disclosure in more detail;

FIG. 5 is a diagram illustrating a configuration in which gesture recognition apparatuses according to an embodiment of the present disclosure communicate with an external server;

FIG. 6 shows an exemplary gesture list that is usable in the gesture recognition apparatus according to an embodiment of the present disclosure;

FIG. 7 shows an exemplary gesture group list that is usable in the gesture recognition apparatus according to an embodiment of the present disclosure;

FIG. 8 shows an exemplary gesture list that is usable when a gesture recognition function according to an embodiment of the present disclosure is applied to a washing machine;

FIG. 9 shows an exemplary gesture list that is usable when the gesture recognition function according to an embodiment of the present disclosure is applied to a refrigerator;

FIG. 10 shows an exemplary gesture list that is usable when the gesture recognition function according to the embodiment of the present disclosure is applied to an oven;

FIG. 11 shows an exemplary gesture list that is usable when the gesture recognition function according to the embodiment of the present disclosure is applied to a styler; and

FIG. 12 shows an exemplary gesture list that is usable when the gesture recognition function according to the embodiment of the present disclosure is applied to a television.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily explain various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that, although the terms “first”, “second”, and the like may be used herein to describe various elements, these elements should not be limited by these terms. These terms are generally only used to distinguish one element from another. It will be understood that when an element is referred to as being “connected with” another element, the element can be directly connected with the other element or intervening elements may also be present. In contrast, when an element is referred to as being “directly connected with” another element, there are no intervening elements present.

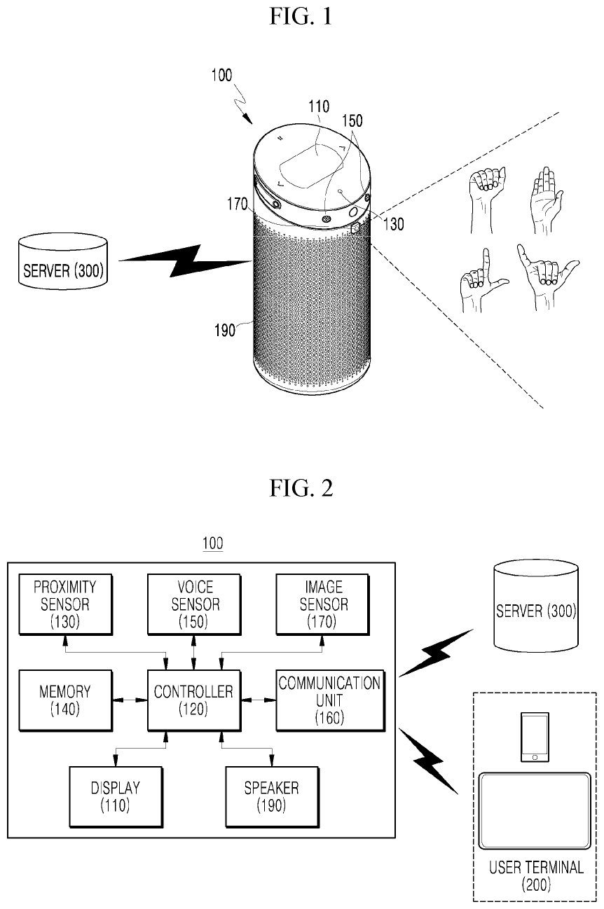

FIG. 1 is a diagram illustrating the whole of a gesture recognition system according to an embodiment of the present disclosure. The gesture recognition system may include a gesture recognition apparatus 100 and a server 300. In FIG. 1, the gesture recognition apparatus 100 includes a display 110 for interfacing with a user, a proximity sensor 130 for sensing approach of the body of the user, a voice sensor 150 for receiving the user's voice, an image sensor 170 for capturing the user's gesture, and a speaker 190 for outputting a sound.

In addition, the server 300 includes an external server communicably connected to the gesture recognition apparatus 100. In more detail, the server 300 can receive information about a gesture and data about a voice from the gesture recognition apparatus 100, and perform data processing and analysis in order to determine what action a user desires through the gesture or the voice. The server 300 can identify a specific gesture from an image of the received gesture or information about the gesture using artificial intelligence technology, particularly various kinds of machine learning.

Further, artificial intelligence (AI) is an area of computer engineering science and information technology that studies methods to make computers mimic intelligent human behaviors such as reasoning, learning, self-improving, and the like. In addition, artificial intelligence does not exist on its own, but is rather directly or indirectly related to a number of other fields in computer science. In recent years, there have been numerous attempts to introduce an element of AI into various fields of information technology to solve problems in the respective fields.

In more detail, machine learning is an area of artificial intelligence that includes the field of study that gives computers the capability to learn without being explicitly programmed. More specifically, machine learning is a technology that investigates and builds systems, and algorithms for such systems, which are capable of learning, making predictions, and enhancing their own performance on the basis of experiential data. Machine learning algorithms, rather than only executing rigidly set static program commands, can be used to take an approach that builds models for deriving predictions and decisions from inputted data.

Further, numerous machine learning algorithms have been developed for data classification in machine learning. Representative examples of such machine learning algorithms for data classification include a decision tree, a Bayesian network, a support vector machine (SVM), an artificial neural network (ANN), and so forth.

In more detail, a decision tree refers to an analysis method that uses a tree-like graph or model of decision rules to perform classification and prediction. Further, a Bayesian network may include a model that represents the probabilistic relationship (conditional independence) among a set of variables. Bayesian network may be appropriate for data mining via unsupervised learning.

An SVM may include a supervised learning model for pattern detection and data analysis, heavily used in classification and regression analysis. Also, an ANN is a data processing system modelled after the mechanism of biological neurons and interneuron connections, in which a number of neurons, referred to as nodes or processing elements, are interconnected in layers.

Further, ANNs are models used in machine learning and may include statistical learning algorithms conceived from biological neural networks (particularly of the brain in the central nervous system of an animal) in machine learning and cognitive science. ANNs also refer generally to models that have artificial neurons (nodes) forming a network through synaptic interconnections, and acquires problem-solving capability as the strengths of synaptic interconnections are adjusted throughout training.

In addition, an ANN may include a number of layers, each including a number of neurons. Furthermore, the ANN may include synapses that connect the neurons to one another. An ANN can also be defined by the following three factors: (1) a connection pattern between neurons on different layers; (2) a learning process that updates synaptic weights; and (3) an activation function generating an output value from a weighted sum of inputs received from a previous layer.

ANNs may include, but are not limited to, network models such as a deep neural network (DNN), a recurrent neural network (RNN), a bidirectional recurrent deep neural network (BRDNN), a multilayer perception (MLP), and a convolutional neural network (CNN). An ANN may be classified as a single-layer neural network or a multi-layer neural network, based on the number of layers therein.

In general, a single-layer neural network may include an input layer and an output layer, and a multi-layer neural network may include an input layer, one or more hidden layers, and an output layer. That is, the input layer receives data from an external source, and the number of neurons in the input layer is identical to the number of input variables. The hidden layer is located between the input layer and the output layer, and receives signals from the input layer, extracts features, and feeds the extracted features to the output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

Further, a deep neural network with a plurality of hidden layers between the input layer and the output layer may be the most representative type of artificial neural network which enables deep learning, which is one machine learning technique.

In addition, an ANN can be trained using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons. An ANN trained using training data can also classify or cluster inputted data according to a pattern within the inputted data.

Throughout the present specification, an artificial neural network trained using training data may be referred to as a trained model. Hereinbelow, learning paradigms of an artificial neural network will be described in detail. Learning paradigms, in which an artificial neural network operates, may be classified into supervised learning, unsupervised learning, semi-supervised learning, and reinforcement learning.

Supervised learning is a machine learning method that derives a single function from the training data. Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label. Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data. Further, throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set. The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label. More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis. Further, examples of artificial neural networks using unsupervised learning include, but are not limited to, a generative adversarial network (GAN) and an auto-encoder (AE).

In more detail, a GAN is a machine learning method in which two different artificial intelligences, a generator and a discriminator, improve performance through competing with each other. In addition, the generator may be a model generating new data that generates new data based on true data. The discriminator may be a model recognizing patterns in data that determines whether inputted data is from the true data or from the new data generated by the generator.

Furthermore, the generator can receive and learn from data that has failed to fool the discriminator, while the discriminator can receive and learn from data that has succeeded in fooling the discriminator. Accordingly, the generator can evolve so as to fool the discriminator as effectively as possible, while the discriminator evolves so as to distinguish, as effectively as possible, between the true data and the data generated by the generator.

Also, an auto-encoder (AE) is a neural network which aims to reconstruct its input as output. More specifically, AE may include an input layer, at least one hidden layer, and an output layer. Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding. Furthermore, in the AE, the inputted data is represented as hidden layer data as interneuron connection strengths are adjusted through training. The fact that when representing information, the hidden layer can reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data. One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data. Reinforcement learning may be performed mainly through a Markov decision process.

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network. For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning. For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto. Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function. The direction in which the model parameters are to be adjusted may be referred to as a step direction, and a size by which the model parameters are to be adjusted may be referred to as a step size. Here, the step size may mean a learning rate.

GD obtains a slope of the cost function through use of partial differential equations, using each of model parameters, and updates the model parameters by adjusting the model parameters by a learning rate in the direction of the slope. Also, SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy. Not only may the server 300 extract a specific gesture from an input image using the above-described artificial intelligence technology, but the gesture recognition apparatus 100 may also extract a specific gesture from the input image using the artificial intelligence technology.

However, the gesture recognition apparatus 100, which is a local device that generally has smaller processing resources than the server 300, may perform artificial intelligence learning using a relatively small amount of data and a relatively simple learning model. The display 110 of the gesture recognition apparatus 100 may display a specific message to a user, or may receive a specific message from the user through a touch-based instruction.

Further, the proximity sensor 130, which is a sensor for determining whether a human body is approaching within a predetermined range, may be an infrared sensor or a photo sensor. Upon determining through the proximity sensor 130 that the human body has approached within the predetermined range, the gesture recognition apparatus 100 activates the image sensor 170 so as to be ready to receive a gesture.

As shown in FIG. 1, the image sensor 170 can capture various gestures. Further, the image captured or sensed by the image sensor 170 can be input to the gesture recognition apparatus 100 so as to be processed and analyzed, and a processor or a controller of the gesture recognition apparatus 100 can determine the type of the gesture or the meaning of the gesture.

When the type of the gesture is determined by the processor to be a first type, which is a type that can be relatively easily analyzed, the gesture recognition apparatus 100, which is a local device, can on its own identify the gesture and understand the content of a command indicated by the gesture in order to perform the command indicated by the gesture.

In contrast, when the type of the gesture is a second type, which is a type that can be relatively complicatedly analyzed, the gesture recognition apparatus 100 can transmit information about the gesture to the external server 300 such that the external server 300, which is abundant in processing resources, identifies the gesture and understands the content of the command indicated by the gesture.

In additions, as shown in FIG. 1, the gesture recognition apparatus 100 includes a voice sensor 150 for receiving a user's voice in addition to the image. The voice sensor 150, which is a microphone, can sense an external sound, and particularly collects a user's voice in order to detect whether the user utters a wake-up word for waking up the gesture recognition apparatus 100 and whether the user issues a command or asks a question by voice. The gesture recognition apparatus 100 may also include a speaker 190 for outputting a sound, in order to output information necessary for the user using voice or to reproduce a sound file, such as music, according to an instruction of the user.

Next, FIG. 2 is a block diagram of a gesture recognition apparatus according to an embodiment of the present disclosure and external devices with which the gesture recognition apparatus communicates. As shown, the gesture recognition apparatus 100 may include a display 110 for externally displaying information, a proximity sensor 130 for sensing approach of a human body, a memory 140 for storing, for example, various kinds of information and learning models, a voice sensor 150 for sensing a user's voice, a communicator 160 for communicating with external devices, an image sensor 170 for sensing a captured image of the outside, a speaker 190, and a controller 120 for interacting with and controlling the these components.

In addition, the gesture recognition apparatus 100 may communicate with a user terminal 200, which is an external device, and may also communicate with the external server 300, as described above. The gesture recognition apparatus 100 can also communicate with various electronic devices over a home network connected through 5G.

A command or a question that the gesture recognition apparatus 100 receives through a user's voice or gesture can be transmitted to other electronic devices that communicate with the gesture recognition apparatus 100, such as a washing machine, a refrigerator, an oven, a styler, and a TV, in order to control these devices. When the voice or the gesture is of a relatively simple type, the gesture recognition apparatus 100 can analyze the voice or the gesture on its own in order to understand the content of the command or the question. When the voice or the gesture is of a relatively complicated type, however, the gesture recognition apparatus 100 can transmit information about the voice or the gesture to the external server 300, which is abundant in processing resources, or to an external device having higher performance.

In an embodiment, a relatively simple gesture may be a wake-up word constituted by a simple gesture, and a relatively complicated gesture may be a gesture constituted by more diverse forms that denote concrete commands after the wake-up word. In another embodiment, a relatively simple gesture may be a gesture constituted by a single form, and a relatively complicated gesture may be a gesture constituted by two or more successive forms having a meaning.

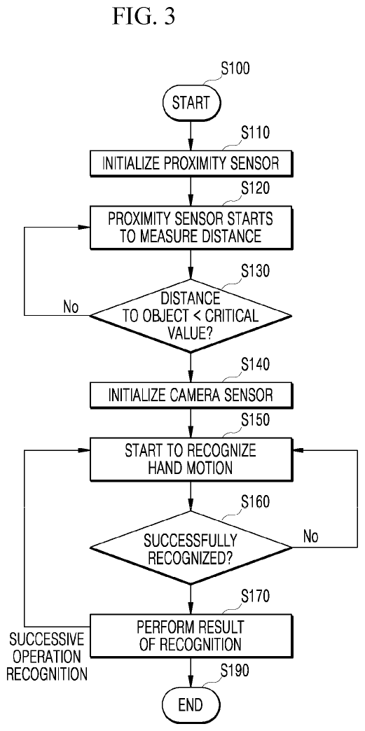

Next, FIG. 3 is a flowchart illustrating a gesture recognition method according to an embodiment of the present disclosure. As shown, the gesture recognition apparatus 100 initializes the proximity sensor 130 so as to accurately sense a distance (S110). Further, the proximity sensor 130 starts to measure the distance to a human body approaching the gesture recognition apparatus 100 (S120). An infrared sensor, an operation sensor, or a camera may be used in order to determine whether the human body is approaching the gesture recognition apparatus 100. The camera can directly capture an image of the outside, and the processor or the controller 120 can determine whether an approaching object is the body of a human being or a hand of the human being through the captured image.

When a user approaches within a predetermined distance to the gesture recognition apparatus 100 in order to input a command to the gesture recognition apparatus 100, such that the distance to the object, recognized by the proximity sensor 130, becomes less than a predetermined critical value (S130), the proximity sensor 130 initializes a camera sensor (S140).

The camera sensor or the image sensor can then start to recognize the hand motion of the user (S150). Further, the processor or the controller 120 of the gesture recognition apparatus 100 determines whether the hand motion has been successfully recognized (S160). When the hand motion is not recognized, the hand motion may be recognized again.

When the hand motion is successfully recognized, the processor or the controller 120 of the gesture recognition apparatus 100 performs a command indicated by the gesture based on the recognized result (S170). When a first gesture is recognized and then a second gesture is successively sensed, the hand motion about the second gesture is recognized (S150). Subsequently, it may be determined whether the second gesture has been successfully recognized in the same manner as the first gesture, and when the second gesture is successfully recognized, the result of recognition about the second gesture can be performed. When there is no further gesture input, the gesture recognition procedure may end.

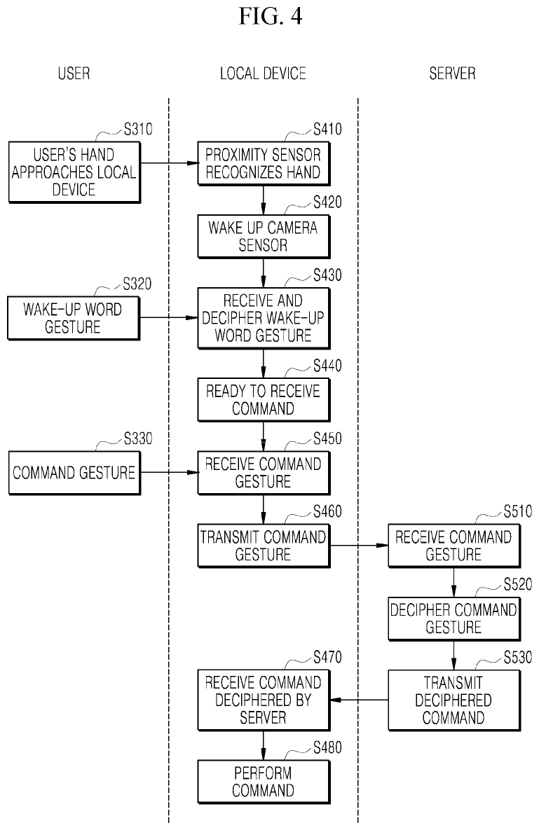

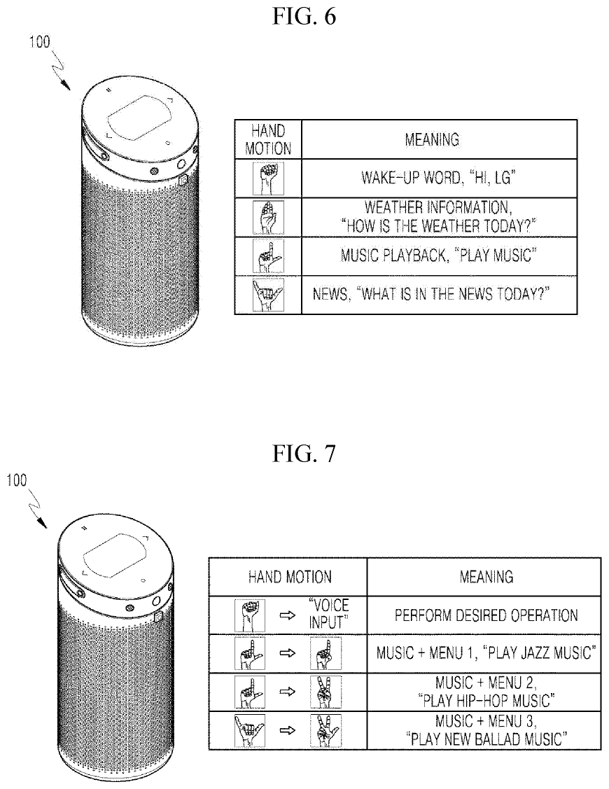

Next, FIG. 4 is a flowchart illustrating the gesture recognition method according to the embodiment of the present disclosure in more detail. Further, FIG. 6, which shows an exemplary gesture list that is usable in the gesture recognition apparatus according to the embodiment of the present disclosure, will also be referred to in order to describe the gesture recognition process in more detail.

First, a user can move his or her hand toward the gesture recognition apparatus 100, which is a local device, in order to input a command to the gesture recognition apparatus 100 (S310). The gesture recognition apparatus 100, which is a local device, can recognize the hand of the user through the proximity sensor 130 (S410).

Upon recognizing through the proximity sensor 130 that the hand of the user has approached the gesture recognition apparatus 100, the camera sensor is woken up so as to receive a gesture (S420). After approaching the gesture recognition apparatus 100, the user can make the camera sensor recognize a fist form, as an agreed wake-up word signal, for example, as shown in the gesture list of FIG. 6 (S320).

Upon receiving an external image through the camera sensor or the image sensor, the controller 120 can determine the gesture corresponding to the input image, and determine the type of the gesture based on whether the gesture is a gesture constituted by a simple form, such as a fist or a palm or is a complicated gesture requiring the direction of each finger to be accurately identified.

That is, when the gesture is constituted by a fist form, in which all fingers are folded, like the wake-up word gesture shown in FIG. 6, or is constituted by a form in which all fingers are unfolded while being kept close to each other, like the weather information gesture shown in FIG. 6, it can be determined that the gesture is a first type gesture, which does not require sophisticated form recognition, and the gesture recognition apparatus 100, which is a local device, can identify the gesture on its own, determine a command indicated by the gesture, and perform the command.

However, when the gesture is a second type of gesture, which is classified as such depending on whether a predetermined number of fingers are unfolded and which fingers are unfolded or in which direction each finger is directed, like the music play gesture or the news gesture shown in FIG. 6, the gesture input image can be transmitted to the external server 300, which is abundant in processing resources. The reason for this is that the external server 300, which is abundant in processing resources, is capable of identifying such a sophisticated gesture and performing the corresponding command indicated by the gesture. Even when the local device is equipped with a processor capable of performing only simple recognition, therefore, it is possible to accurately provide a service desired by the user through accurate gesture identification.

Here, the information transmitted to the external server 300 may be the gesture input image itself, or an input image that is more simply processed in order to conserve transmission and reception resources. The input image that is more simply processed may be a low-quality image or simplified gesture data indicating information about the directions of fingers making the gesture, rather than the original input image.

Referring back to FIG. 4, when the user makes a wake-up word gesture in a first form, and when the gesture recognition apparatus 100 receives the first form and determines the first form to be the wake-up word gesture, the controller 120 activates the image sensor 130, which is capable of capturing the gesture in more detail, and stand by to receive a command (S440).

For example, the image sensor 130 may include a first image sensor, which has relatively low performance, and a second image sensor, which has relatively high performance. When the image sensor is initially awakened after the hand recognition is performed by the proximity sensor 130, the controller 120 can activate only the first image sensor. When the user interacts with the gesture recognition apparatus 100 in order to show a wake-up word gesture as a meaning to transmit a command and in which the controller 120 determines the user's gesture to be the wake-up word gesture, the controller 120 can activate the second image sensor in order to acquire a more detailed gesture input image.

Here, the first image sensor may be a mono camera, and the second image sensor may be an additional camera. When the first image sensor and the second image sensor are simultaneously activated, therefore, the first image sensor and the second image sensor can function as a stereoscopic camera.

After the second image sensor is also activated, the user can perform a concrete command gesture (S330). The gesture recognition apparatus 100 receives the command gesture, and, upon determining that the received command gesture is of a more complicated gesture type, can transmit the command gesture to the external server 300. The gesture recognition apparatus 100 can, on its own, identify a gesture in a simple form, like the weather information gesture shown in FIG. 6 among possible command gestures, determine the content of the command, and perform the command. However, for convenience of description, in the flowchart of FIG. 4, it is assumed that the wake-up word gesture is a simple gesture and the command gestures are more complicated gestures.

In addition, the external server 300 receives the command gesture (S510), identifies the form of the gesture, and deciphers the gesture in order to find a command corresponding thereto (S520). For example, when the external server 300 receives the music play gesture of FIG. 6, the external server 300 can identify that the gesture has a form in which the thumb and the index finger are unfolded at a right angle to each other and the other fingers are folded, and decipher the gesture having the above form as corresponding to a command for playing music.

Here, the external server 300 may identify the gesture using a deep neural network model pre-trained to analyze an input image for gesture identification and to specify a corresponding gesture. The process in which the deep neural network model is trained may be constituted by supervised learning, and learning may be performed using data in which captured images of numerous finger forms are labeled to indicate which gesture corresponds to the finger form included in each image.

Further, the deep neural network model trained through the above learning can be transmitted to the gesture recognition apparatus 100, which is a local device, and the gesture recognition apparatus 100 can process the input image to specify the gesture using the received pre-trained deep neural network model.

Referring back to FIG. 4, the external server 300 can identify that the gesture has a form in which the thumb and the index finger are unfolded at a right angle to each other and the other fingers are folded, decipher the gesture having the above form as corresponding to a command for playing music, and transmit the command for playing music to the gesture recognition apparatus 100 (S530). The communicator 160 of the gesture recognition apparatus 100 can receive the command for playing music (S470), and play music according to the command (S480).

Also, in FIG. 4, the wake-up word for waking up the gesture recognition apparatus 100 has been described as being received as a gesture. In some embodiments, however, the wake-up word may be received as a voice signal, and the commands may be received as gestures. That is, when the user approaches the gesture recognition apparatus 100 and says an agreed wake-up word such as “Hi, LG,” the controller 120 can determine that the voice signal corresponds to the agreed wake-up word, and activate the image sensor such that a gesture may be received.

In another embodiment, when the user approaches the gesture recognition apparatus, the controller 120 can sense the approach of the user through the proximity sensor, and activate the image sensor. When the user makes a wake-up word gesture, the controller 120 can activate a voice recognition mode, and cause the gesture recognition apparatus 100 to be ready to receive an additional voice command of the user.

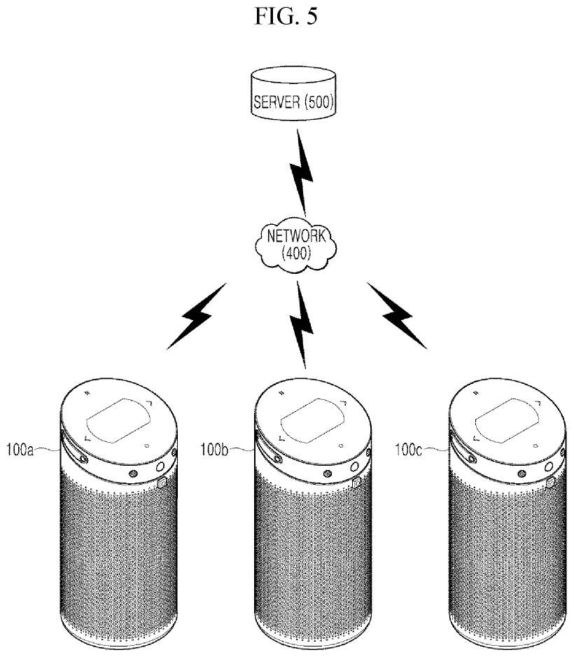

Next, FIG. 5 is a diagram illustrating a configuration in which gesture recognition apparatuses according to an embodiment of the present disclosure communicate with an external server. As shown, the external server 500 may be connected to several gesture recognition apparatuses 100a, 100b, and 100c over a network 400. As a result, information about gestures received from gesture recognition apparatuses located in respective homes may be cumulatively stored in the server 500.

Further, the external server 500 can statistically analyze gestures that are frequently input in specific regions or in specific time zones using the cumulative information, and upgrade a deep neural network model for gesture identification so as to more accurately identify gestures based on context through the deep neural network model. In addition, the external server can, through the cumulative information, predict which gesture corresponding to which command will be input, and may cause gesture recognition apparatuses or other electronic devices located in respective homes to be ready to perform tasks according to commands to be issued by users.

As discussed above, FIG. 6 shows an exemplary gesture list that is usable in the gesture recognition apparatus according to an embodiment of the present disclosure. A simple fist form may correspond to a wake-up word voice such as “Hi, LG” as a wake-up word gesture. Further, a gesture having a form in which all fingers are unfolded to expose the palm may correspond to a voice command such as “How is the weather today?” as a command for requesting weather information. A gesture in which the thumb and the index finger are unfolded at an approximately right angle to each other while the other fingers are folded may be agreed upon as a command for requesting music playback, and may correspond to a voice command such as “Play music.” A gesture in which the thumb and the little finger are unfolded while the other fingers are folded may be agreed upon as a command for requesting news, and may correspond to a voice command such as “What is in the news today?”

In addition, FIG. 7 shows an exemplary gesture group list that is usable in the gesture recognition apparatus according to an embodiment of the present disclosure, although the case in which in a single gesture corresponds to a single command is shown in FIG. 6. First, a combination of a gesture and a voice command will be described. When the user makes a fist gesture agreed upon as a wake-up word and then issues a specific command by voice, the gesture recognition apparatus 100 can wake up and perform an action that the user desires, instructed by the user using his or her voice.

A command being performed using a combination of gestures will be described below. When the user makes a gesture requesting music playback and then makes a gesture in which only the index finger is unfolded, this can be recognized as a command for playing jazz music, assigned to menu 1. When the user makes a gesture requesting music playback and then makes a gesture in which two fingers are unfolded, this can be recognized as a command for playing hip-hop music, assigned to menu 2.

As another example, when the user makes a gesture requesting music playback and then makes a gesture in which three fingers are unfolded, this can be recognized as a command for playing new ballad music, assigned to menu 3. When a combination of a first gesture and a second gesture is input, that is, when the controller 120 successively senses a first input image indicating the first gesture and a second input image indicating the second gesture within a predetermined time, each gesture may not be processed as a separate command gesture, but the two gestures can be combined into a single group in order to decipher a command.

Further, the controller 120 can group the first gesture and the second gesture in order to create gesture group data, and then process the gesture group data on its own or transmit the gesture group data to the external server 300. Upon receiving the gesture group data, the external server 300 can recognize the gestures in the data as gestures that are related to each other, and combine the two gestures, as described above, so as to correspond to a single command. In addition, the function of the gesture recognition apparatus 100 may be performed not only by an artificial intelligence speaker, which has been described above for exemplary purposes, but may also be applied to other electronic devices.

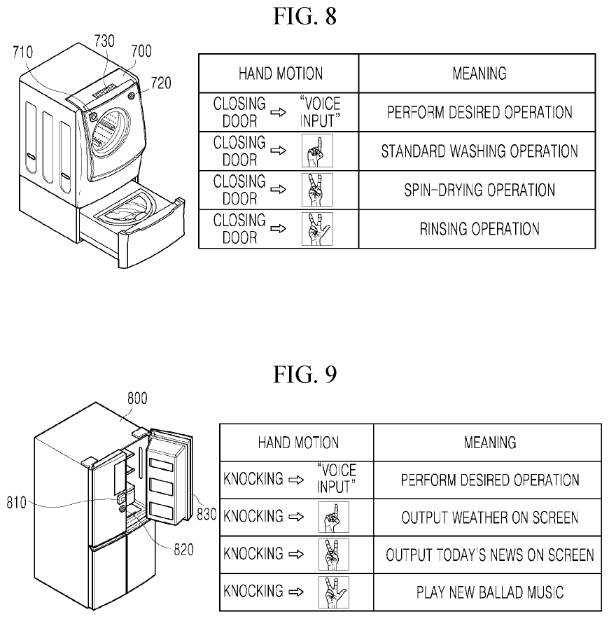

Next, FIG. 8 shows an exemplary gesture list that is usable when a gesture recognition function according to an embodiment of the present disclosure is applied to a washing machine. As shown, the washing machine 700 may include a camera 710 for sensing a gesture, a proximity sensor 720 for sensing approach of a user, and a speaker 730 for outputting a sound.

In order to use the washing machine, it is necessary to open and then close a door. Consequently, closing the door to the washing machine may be set as a wake-up word, and a voice signal or a gesture signal input after the door is closed may be recognized as a command to be performed.

When a voice command is received after the door is closed, the washing machine can perform a desired operation according to the voice command. When a gesture is input after the door is closed, a gesture command can be set such that the washing machine performs a standard washing operation, a spin-drying operation, or a rinsing operation depending on the number of fingers that are unfolded.

Next, FIG. 9 shows an exemplary gesture list that is usable when the gesture recognition function according to the embodiment of the present disclosure is applied to a refrigerator 800. The refrigerator can be set to show information desired by the user through a display disposed on a door, or to output a sound through a speaker disposed in the refrigerator as the result of knocking on the door.

As shown, the refrigerator 800 may include a camera 810 for sensing a gesture, a proximity sensor 820 for sensing approach of a user, and a display 830 disposed on a door. Also, a knocking operation, which is an operation of knocking on the door, can be set as a wake-up word, and when a voice or a gesture is inputted after the door is knocked on, the refrigerator may perform a specific action.

For example, the refrigerator can determine whether to output weather or today's news through a screen disposed on the door of the refrigerator depending on the number of fingers that are unfolded after the door is knocked on. The refrigerator can also be set to play new ballad music through a speaker in the refrigerator when three fingers are unfolded after the door is knocked on.

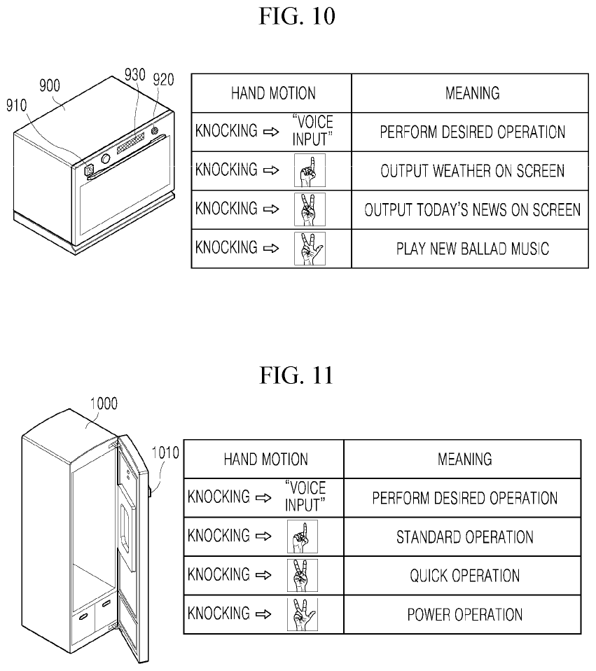

FIG. 10 shows an exemplary gesture list that is usable when the gesture recognition function according to the embodiment of the present disclosure is applied to an oven. As shown, the oven 900 may include a camera 910 for sensing a gesture, a proximity sensor 920 for sensing approach of a user, and a speaker 930 for outputting a sound.

In a manner similar to the refrigerator, a knocking operation, which is an operation of knocking on a door, can be set as a wake-up word, and when a voice or a gesture is inputted after the door is knocked on, the oven can perform a specific action. For example, the oven can determine whether to output weather, to output today's news, or to play new ballad music through a display disposed on the oven or through the speaker depending on the number of fingers that are unfolded after the door is knocked on.

FIG. 11 shows an exemplary gesture list that is usable when the gesture recognition function according to the embodiment of the present disclosure is applied to a styler. As shown, the styler 1000 may include a camera 1010 for sensing a gesture. In some embodiments, the styler 1000 may further include a proximity sensor for sensing approach of a user and a speaker for outputting a sound.

In a manner similar to the refrigerator and the oven, a knocking operation, which is an operation of knocking on a door, may be set as a wake-up word, and when a voice or a gesture is inputted after the door is knocked on, the styler may perform a specific action. For example, the styler can be set to perform one of a standard operation, a quick operation, and a power operation depending on the number of fingers that are unfolded after the door is knocked on.

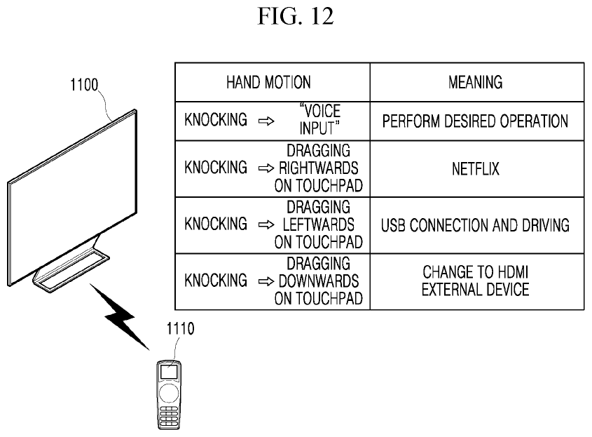

FIG. 12 shows an exemplary gesture list that is usable when the gesture recognition function according to the embodiment of the present disclosure is applied to a television. As shown, the television 1100 may communicate with a remote controller 1110, and the remote controller 1110 may include a touchpad for sensing a touch.

In a manner similar to the refrigerator, the oven, and the styler, a knocking operation, which is an operation of knocking on a screen or a predetermined portion of the remote controller, can be set as a wake-up word, and when a voice or a gesture is inputted after the screen or a predetermined portion of the remote controller is knocked on, the television can perform a specific action. For example, the television can perform a Netflix play operation, a play through USB connection operation, or a play through HDMI connection operation depending on a motion inputted to the touchpad after the remote controller is knocked on.

Application of the gesture recognition apparatus and method according to the embodiments of the present disclosure are not limited the configurations and methods of the embodiments described herein. Rather, all or some of the embodiments may be selectively combined to achieve various modifications.

Also, in another embodiment of the present disclosure, at least one program configured for a computer to perform the method according to the above embodiment of the present disclosure when executed by the computer may be stored in a computer-readable storage medium.

The present disclosure described above is not limited by the aspects described herein and the accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. A gesture recognition apparatus comprising:
an image sensor configured to sense an input image;
a communicator configured to communicate with an external server; and
a controller configured to:
determine a gesture included in the input image and a type of the gesture;
determine a command indicated by the gesture and perform the command when the gesture is a first type of gesture; and
control the communicator to transmit information about the gesture to the external server when the gesture is a second type of gesture.

2. The gesture recognition apparatus according to claim 1, wherein the controller is further configured to determine the type of gesture by processing the input image through a deep neural network model pre-trained to specify a corresponding gesture included in an image.

3. The gesture recognition apparatus according to claim 1, further comprising:
a voice sensor configured to sense a voice,
wherein the controller is further configured to activate the image sensor upon determining that sensed voice corresponds to a wake-up word for waking up the gesture recognition apparatus.

4. The gesture recognition apparatus according to claim 1, further comprising:
a proximity sensor configured to sense a human body approaching within a predetermined range of the gesture recognition apparatus,
wherein the controller is further configured to activate the image sensor when the proximity sensor senses the human body.

5. The gesture recognition apparatus according to claim 4, wherein the image sensor comprises a first image sensor and a second image sensor, and
wherein the controller is further configured to:
initially activate only the first image sensor; and
secondarily activate the second image sensor in addition to the first image sensor upon determining that an image sensed by the first image sensor includes a wake-up gesture.

6. The gesture recognition apparatus according to claim 4, further comprising:
a voice sensor configured to sense a voice,
wherein the controller is further configured to activate a voice recognition mode upon determining that the gesture included in the input image sensed by the image sensor includes a wake-up gesture.

7. The gesture recognition apparatus according to claim 1, wherein when the gesture is the second type of gesture, the controller is further configured to:
convert the input image into simplified gesture data comprising information about directions of fingers making the gesture, and
control the communicator to transmit the simplified gesture data to the external server as information about the gesture.

8. The gesture recognition apparatus according to claim 1, wherein when a first input image indicating a first gesture and a second input image indicating a second gesture, received by the image sensor, are successively sensed within a predetermined time, the controller is further configured to:
create gesture group data in which the first gesture and the second gesture are grouped, and
control the communicator to transmit the gesture group data to the external server as information about the gesture.

9. The gesture recognition apparatus according to claim 1, wherein the gesture recognition apparatus is installed in a home appliance.

10. The gesture recognition apparatus according to claim 1, wherein the first type of gesture is a simpler gesture than the second type of gesture.

11. The gesture recognition apparatus according to claim 10, wherein the first type of gesture includes a closed fist gesture and the second type of gesture includes at least one finger extended.

12. A gesture recognition method, comprising:
sensing an input image through an image sensor;
determining, via a controller, a gesture included in the input image and a type of the gesture;
determining, via the controller, a command indicated by the gesture and performing the command when the gesture is a first type of gesture; and
transmitting, via a communicator, information about the gesture to an external server when the gesture is a second type of gesture.

13. The gesture recognition method according to claim 12, wherein the type of gesture is determined by processing the input image through a deep neural network model pre-trained to specify a corresponding gesture included in an image.

14. The gesture recognition method according to claim 12, further comprising:
sensing a voice through a voice sensor;
determining whether the sensed voice corresponds to a wake-up word; and
activating the image sensor when the voice signal corresponds to the wake-up word.

15. The gesture recognition method according to claim 12, further comprising:
sensing a human body approaching within a predetermined range through a proximity sensor; and
activating the image sensor upon determining that the proximity sensor senses the human body.

16. The gesture recognition method according to claim 15, wherein the image sensor comprises a first image sensor and a second image sensor,
wherein activating the image sensor comprises activating only the first image sensor, and
wherein sensing the input image through the image sensor comprises:
determining whether a gesture corresponding to an image sensed by the first image sensor is a wake-up gesture;
activating the second image sensor in addition to the first image sensor when the gesture corresponding to the image is the wake-up gesture; and
sensing the input image through the first image sensor and the second image sensor.

17. The gesture recognition method according to claim 12, further comprising:
activating a voice recognition mode when the gesture is a wake-up gesture.

18. The gesture recognition method according to claim 12, wherein transmitting information about the gesture to the external server comprises:
converting the input image into simplified gesture data comprising information about directions of fingers making the gesture when the gesture is the second type of gesture; and
transmitting the simplified gesture data to the external server as information about the gesture.

19. The gesture recognition method according to claim 12, wherein when a first input image indicating a first gesture and a second input image indicating a second gesture, received by the image sensor, are successively sensed within a predetermined time, transmitting information about the gesture to the external server comprises:
creating gesture group data in which the first gesture and the second gesture are grouped; and
transmitting the gesture group data to the external server as information about the gesture.

20. A computer-readable recording medium recording a computer program to execute the method according to claim 12 using a computer.
